(19) United States
(12) Patent Application Publication
(10) Pub. No.: US 2010/0229644 A1
(43) Pub. Date: Sep. 16, 2010

(54) FOOD AND BEVERAGE DEVICES

(76) Inventor: Gail P. Curtis, Eugene, OR (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/696,587

(22) Filed: Jan. 29, 2010

Related U.S. Application Data
(60) Provisional application No. 61/206,366, filed on Jan. 30, 2009.

(51) Int. Cl. G01F 19/00

(52) U.S. Cl. 73/427

(57) ABSTRACT

A beverage and food measurement system for indicating when a measured quantity of a beverage or food has been obtained.

### CROSS-REFERENCE TO RELATED APPLICATIONS

This application claims the benefit of Provisional App. No. 61/206,366, filed Jan. 30, 2009.

### BACKGROUND OF THE INVENTION

The present invention relates to a beverage and food measurement system for indicating when a measured quantity of a beverage or food has been obtained.

Wine is widely consumed in varying amounts by a large number of people. Wine consumption has been shown to have therapeutic benefits when a particular amount is consumed. The limits of this range vary with gender, age, pre-existing risk factors and diseases. Some studies have suggested that an appropriate consumption of alcohol can reduce cardiovascular mortality by 30%. Other potential health benefits may also result from suitable wine consumption. Other studies have shown that moderate to heavy regular drinking raises mortality. Drunk-driving also continues to be a major contributor to road fatalities, killing drivers, passengers and pedestrians.

For those who are trying to lose weight or otherwise maintain their weight, it is beneficial for them to keep track of their alcoholic consumption. One manner of tracking their wine consumption is to carefully measure out a drink into a measuring cup with marks, such as, 4 ounces, 6 ounces, 8 ounces, 10, ounces, etc. Then the drink is transferred to a wine glass. While effective, it is burdensome to make such measurements. Also, in social situations it is sometimes undesirable to measure using a measuring cup before consuming the wine.

Therefore, it is beneficial to assist people in regulating their alcohol consumption for health and weight management.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 shows a perspective view of a wine glass according to an embodiment.

FIGS. 2A and 2B show a perspective views of a plate according to embodiments.

FIG. 3 shows a perspective view of a bowl according to an embodiment.

### DETAILED DESCRIPTION OF PREFERRED EMBODIMENT

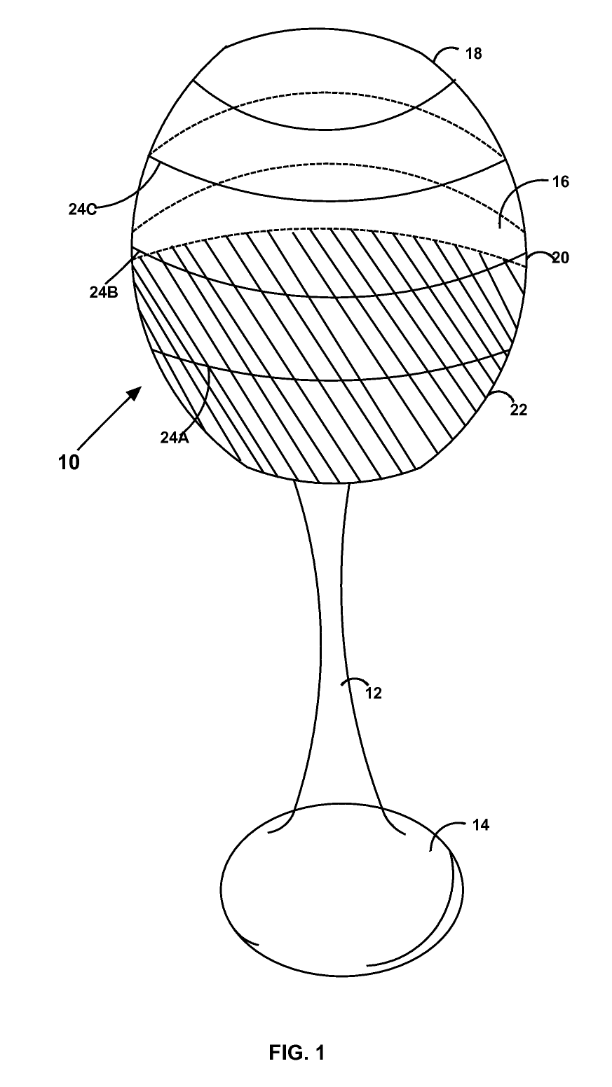

Referring to FIG. 1, a typical wine glass 10 is shown. The wine glass includes an elongate stem 12 which is supported by a circular base 14 (generally referred to as a foot). The stem 12 supports a curved drink bowl 16. The top edge 18 of the bowl 16 typically has a circumference that is less than the central part 20 of the bowl 16. The bowl 16 contains liquid 22 therein, such as wine or other liquids. In some cases, the glass 10 will have a bowl having a uniform cylindrical side, apart from the region for connection to the stem.

The wine glass 10 preferably has a plurality of markings in the form of rings 24A, 24B, and 24C etched into or embossed on the exterior surface of the glass 10. The wine glass 10 may have the markings on the interior surface of the glass 10 or within the glass itself, if desired. The rings 24A-24C extend around the entire circumference of the glass 10 for ease of reference all the way round the glass. Preferably, the rings 24A-24C are continuous around the circumference of the glass 10. Alternatively, the horizontal rings may be around only a portion of the circumference of the glass 10.

In many cases, it is desirable for the drinker of wine or other beverages to be able to discretely measure the amount of liquid that is put into a glass. The discrete measurements may be because the drinker is attempting to lose weight, while still drinking in social situations, or may be tracking alcohol consumption for health related reasons. The rings 24A-24C are preferably accurately positioned to indicate when a measured quantity of wine has been poured into the glass 20. The alcohol content within the glass is given in the form of ounces, such as 4 ounces (24A), 6 ounces (24B), and 8 ounces (24C).

Weight management programs, such as Weight Watchers, permit one to have points to track your food consumption. Such programs may use 4 ounces, 6 ounces, and 8 ounces, as their target for the allocation of points, such as 2 points, 3 points, and 4 points, respectively. In this manner, it is desirable to not include written markings indicating the amount of fluids associated with each of the rings.

Thus the wine glass 20 provides the consumer with a measure of the amount of alcohol (by 4, 6, 8 ounce markings) on the glass, without any stigma that may result from having a glass with written textual markings associated therewith, that they are about to consume. In this way, any uncertainty and confusion surrounding the alcohol content of the glass of wine is avoided in a discrete manner. This is particularly useful in light of the many varying glass sizes and drink sizes for wines and alcoholic beverages that are offered to consumers presenting a health and safety risk.

Recently, there has been an increasing market for so-called ‘sports drinks’ which are specially formulated beverages designed to replace necessary minerals and salts lost during physical exertion, and to replenish energy consumed during heavy exercise. Other formulations are intended to assist with weight-loss, body building or reduction in body mass, etc. Ideally, the consumption of such specially formulated beverages should also be regulated before, during and/or after physical exercise in order to maximize the potential benefits. Therefore the glass (or plastic) may also be used in the field of sports drinks, so that consumers can accurately monitor their calorie, carbohydrate, mineral, protein, etc intake.

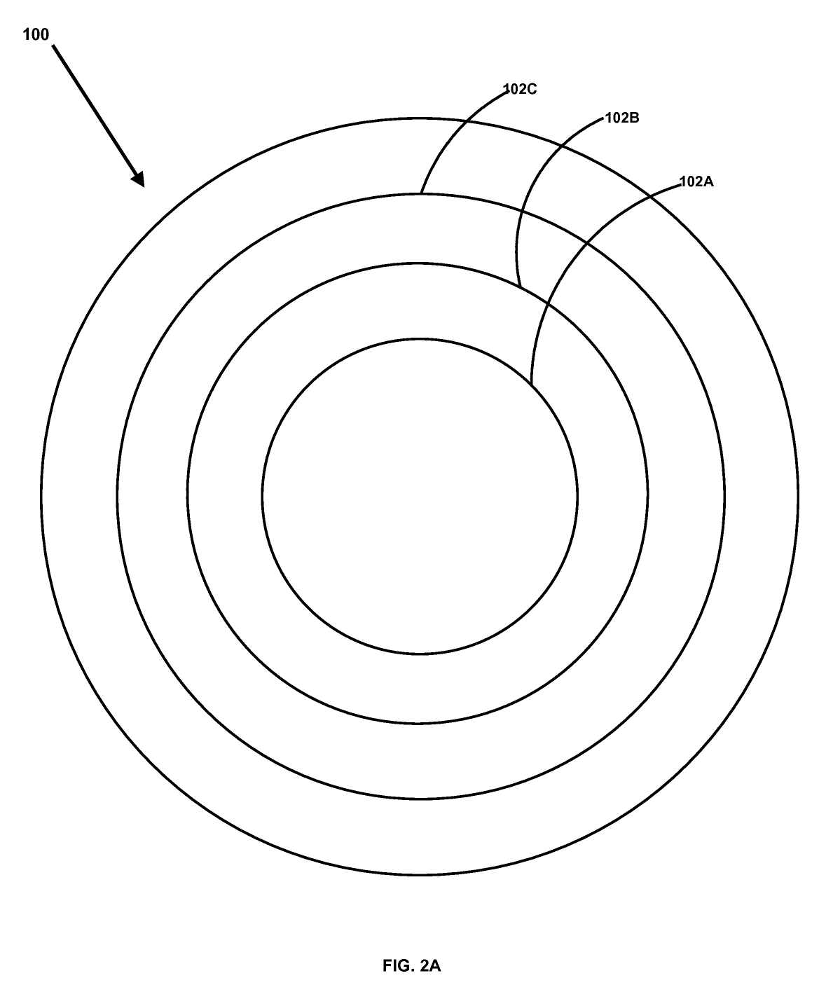

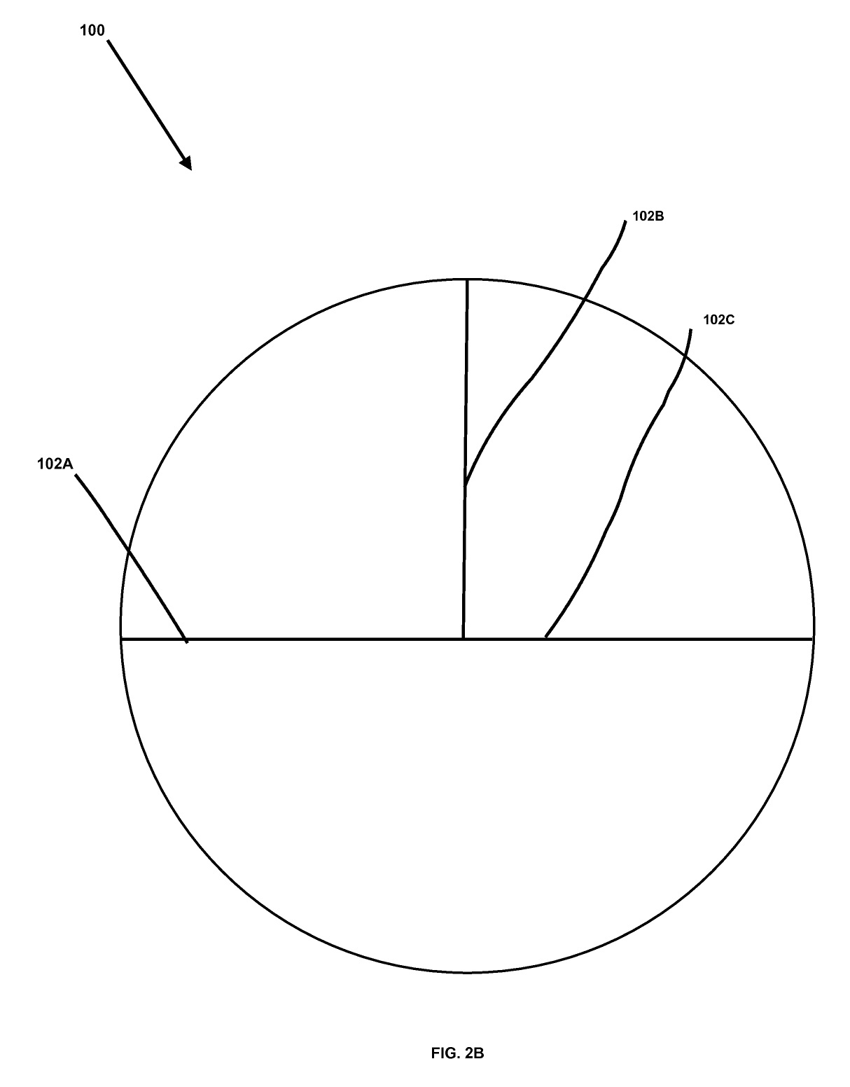

In a similar manner, referring to FIGS. 2A and 2B, a plate 100 may be discretely marked with serving sizes. The serving sizes may be indicated by a series of markings 102A, 102B, and 102C. The plate may be transparent, if desired. The markings 102A-102C may be in the top exterior, on the bottom exterior, or within the plate itself. These markings 102A-102C do not include any associated markings indicating small, medium, or large serving sizes. In this manner, those watching their food consumption can discretely measure their food intake.

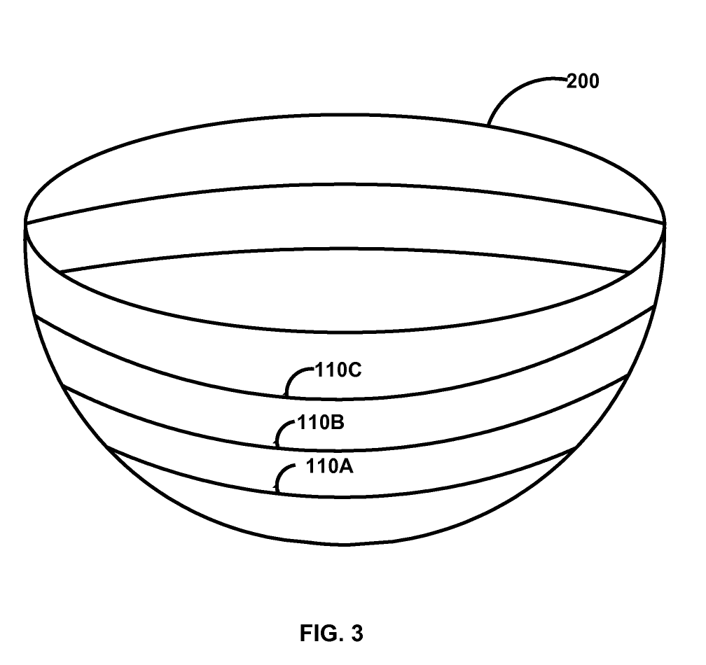

In a similar manner, referring to FIG. 3, a bowl 200 may be discretely marked with serving sizes. The serving sizes may be indicated by a series of markings 110A, 110B, and 110C. The bowl may be transparent, if desired. The markings 110A-110C may be in the top exterior, on the bottom exterior, or within the bowl itself. These markings 110A-110C do not include any associated markings indicating small, medium, or large serving sizes. In this manner, those watching their food consumption can discretely measure their food intake.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A beverage measurement system for a beverage container, the system comprising: a series of markings provided on a surface of said container and positioned to indicate, from the level of beverage in the container, when a quantity of the beverage contained in the container, so that a consumer can determine how much of the beverage is contained in the container, wherein the container does not include markings indicating the amount of beverage associated with the markings.

2. The beverage measurement system according to claim 1 wherein there are no textual markings on a bowl of the container.

3. The beverage measurement system according to claim 2 wherein there are no textual markings on a stem of said container.

4. The beverage measurement system according to claim 3 wherein there are no textual markings on a foot of said container.

5. The beverage measurement system according to claim 1 wherein said markings are embossed or etched into the exterior surface of the container.

6. The beverage measurement system according to claim 1 wherein the beverage container is a wine glass.

7. The beverage measurement system according to claim 1 wherein said markings are embossed or etched on the interior surface of the container.

8. The beverage measurement system according to claim 1 wherein said markings are within the material of the container.

9. The beverage measurement system according to claim 1 wherein the beverage container is a bowl.

10. The beverage measurement system according to claim 1 wherein said beverage container is a plate.
